(19) United States
(12) Patent Application Publication
(10) Pub. No.: US 2025/0171310 A1
(43) Pub. Date: May 29, 2025

(54) Process for Manufacture of Carbon Nanotube Tape-Like Prepeg for Enhanced Composite Properties

(71) Applicant: United States of America as Represented by the Administrator of NASA, Washington, DC (US)

(72) Inventors: Jae-Woo Kim, Newport News, VA (US); John M. Gardner, Newport News, VA (US); Godfrey Sauti, Yorktown, VA (US); Benjamin D. Jensen, Traverse City, MI (US); Joseph G. Smith, JR., Smithfield, VA (US); Scott R. Zavada, Williamsburg, VA (US); Emilie J. Siochi, Newport News, VA (US)

(21) Appl. No.: 18/792,218

(22) Filed: Aug. 1, 2024

Related U.S. Application Data
(60) Provisional application No. 63/602,706, filed on Nov. 27, 2023.

(51) Int. Cl. C01B 32/174; C08J 5/24

(52) U.S. Cl. CPC C01B 32/174; C08J 5/243; C08J 2300/10

(57) ABSTRACT

Methods of forming a tape-like carbon nanotube (CNT) prepreg that may enhance the shear, transverse and axial mechanical properties of composite articles fabricated using the prepreg. Particularly, tape-like prepregs in which a CNT reinforcement material may be impregnated with a thermosetting resin and thermally latent ionic liquid cure agent. Prepregs may be formed of carbon nanotube reinforcement with specific alignment in one direction and continuous high degree of stretch to yield high tenacity and modulus. The CNT prepreg may have a specific cross-sectional aspect ratio between the prepreg width and the thickness that may result in enhanced shear and transverse strength combined with enhanced axial strength where applied to composite materials.

### CROSS-REFERENCE TO RELATED PATENT APPLICATION

This patent application claims the benefit of and priority to 63/602,706, filed on Nov. 27, 2023, the contents of which are hereby incorporated by reference in their entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Carbon nanotubes (CNTs) may comprise of single wall nanotubes, double wall nanotubes, multiwall nanotubes or combinations thereof. They are known to have extraordinary tensile strength, including high strain-to-failure and relatively high tensile modulus, as well as high electrical and thermal conductivity. CNTs may also be highly resistant to fatigue, radiation damage, and heat. To this end, carbon nanotube materials can be used for their tensile strength, thermal, and electrical conductivity properties.

Due to their high electrical and thermal conductivity, carbon nanotube (CNT) materials are being used in a wide variety of electrical applications, including batteries, capacitors, and cables. Due to their mechanical strength, they have potential to be used in applications such as composite overwrapped pressure vessels (COPVs). The high tensile strength and modulus of CNT materials combined with their electrical and thermal properties allow them to be used in multi-functional systems that integrate electrical and thermal applications with structural elements.

Metals which are used for aerospace structures are isotropic and have the required combination of strength and high fracture toughness but are heavy. Carbon fiber composites, which are the state-of-the-art (SOA) materials used for lightweight aerospace structures are anisotropic and have lower toughness. At the nanoscale level, CNTs have tensile properties that have been measured to be orders of magnitude greater than carbon fiber reinforcement and metals. When assembled into fibers to serve as composite reinforcement, the tenacity of the fiber, along with the hierarchical structures in this fiber suggest the potential to enable significantly lighter and tougher aerospace composite structures. However, existing approaches to produce CNT composites for aerospace structural applications severely limit the utility of CNT composites to a very small number of lightweight electrical and tensile driven applications.

While the prospects for using CNT materials in structural applications have advanced over the past two decades thanks to the availability of CNTs manufactured at high volumes, a barrier to adoption in lightweight composite applications is the gap in processing methods that overcome the poor shear properties of CNT fibers. Some structural reinforcements require treatment of the surface to translate shear stresses from the matrix into the fiber because the interface is weaker than both the matrix and fiber in shear. However, treating the surface of CNT fibers has yielded limited improvements because the treated fiber surface-matrix interface has a shear strength that exceeds the shear strength of the “dry” untreated fiber core. Therefore, failure proceeds unencumbered by the surface treatments through the dry fiber core under relatively low shear loads as shown in FIG. 1.

While colloquially the term prepreg refers to a sheet material composed of many tows of filaments, unlike these conventional prepregs, the CNT/epoxy/ionic liquid prepreg produced in the current work (shortened to CNT prepreg herein after) has a single-fiber-like appearance, or with calendaring, a tape-like appearance. It shares with those conventional prepregs the combination of reinforcement (the CNT bundles), impregnated with uncured epoxy matrix and cure agent that allows the building of composite articles and thus the use of that terminology herein. Despite its shape, the term “fiber” will not be used when referring to the prepreg to better distinguish it from the resulting (cured and post-cured) “CNT composite fibers” generated for characterization purposes.

Herein, a method is described for producing an intermediate material for composite fabrication, referred to here as a CNT/epoxy/ionic liquid prepreg, from stretching and aligning CNT roving with polymer and ionic liquid incorporated during the processing. This method enables epoxy infiltration deep into the hierarchical CNT ensemble microstructure to increase the shear strength of the resulting material and increase in the level of stretching to achieve the CNT alignment required for enhanced tenacity. The ionic liquid serves a dual purpose in this process: as a stretching agent and a latent curing agent/hardener for the epoxy. The CNT/epoxy/ionic liquid prepreg can be stored for later use, cured into CNT composite fibers, or used as the building block for the layup of composite articles.

### BRIEF SUMMARY OF THE INVENTION

The invention relates to the fabrication of composite articles with enhanced mechanical properties, and specifically the shear, transverse, and axial properties. Unique to existing approaches, this invention uses CNT material with high linear density of at least 10 tex (g/km). The CNTs in the roving materials are primarily double walled with an average diameter of ˜6 nm. Tape-like CNT prepreg with enhanced interfacial shear strength (IFSS) is the building block to manufacture composite articles which exhibit enhanced shear and transverse properties, as well as high axial strength and modulus.

The present invention is directed to systems and methods for producing a CNT prepreg that may include the steps of providing a loosely networked and porous nanotube material depicted in FIG. 2, introducing the CNT material into a bath comprising ionic liquid and uncured thermosetting resin, stretching the treated CNT material, and applying an electrical potential or current between the CNT material and a counter-electrode in the bath as depicted in FIG. 3 with FIG. 4 showing the influence of various processing parameters on the resulting CNT composite properties. FIG. 5 and FIG. 6 depict embodiments of the current process invention. In some examples, the bath may also contain an organic solvent such that a viscosity of the liquid in the bath is reduced. In another example, the bath may be heated such that a viscosity of the liquid in the bath is reduced. In one example, the ionic liquid comprises a latent cure agent for thermosetting resin polymerization not limited to 1-ethyl-3-methylimidazolium-dicyanamide (EMIM-DCA) and trihexyl(tetradecyl)phosphonium Bis(2,4,4-trimethylpentyl)phosphinate. In still other examples, role of the ion and uncured resin may served by a single substance comprising of polymerizable ionic liquid such as 3,3′-(butane-1,4-diyl)Bis(1-vinyl-3-imidazolium)-Bis(trifluoromethanesulfonyl)imide, 1-vinylimidazolium-bis(trifluoromethanesulfonyl)imide, 1-allyl-3-methylimidazolium-bis(trifluoromethanesulfonyl)imide, 3-ethyl-1-vinylimidazolium Bis(trifluoromethanesulfonyl)imide, 1,3-Bis(1-((7-oxabicycloheptan-3-yl)methoxycarbonyl)methyl)-1H-imidazol-3-ium-Bis(trifluoromethanesulfonimidate), 3,3-(Butane-1,4-diyl)Bis(1-(4-(((7-oxabicycloheptan-3-yl)methoxy)methyl)phenyl)-1H-imidazol-3-ium-Bis(trifluoromethanesulfonimidate) or a combination thereof. In yet other examples, the nanotubes in the CNT material with ionic liquid and uncured thermosetting resin may substantially align relative to one another within the treated and stretched nanotube material.

Processing parameters used to induce alignment include employment of rollers to control degree to which the CNTs line up along the stretch direction. In one example, speeds of an entry roller and an exit roller differ from each other to control a magnitude of stretching during the step of stretching.

In still other examples, the electrical potential between the CNT material and counter electrode is either positive or negative polarity on the CNT material. In one example, the ionic liquid comprises an uncured thermosetting resin that is not limited to EMIM-DCA and trihexyl(tetradecyl)phosphonium Bis(2,4,4-trimethylpentyl)phosphinate. In still other examples, the applied electrical potential or current between the CNT material and a counter-electrode in the bath may be 1 to 200 ampere-minute per gram. In other examples, the method of producing the CNT prepreg may include the steps of washing and densification of the CNT material. In yet another example, the method of producing the CNT prepreg may include the step of calendaring the CNT prepreg to produce a tape-like CNT prepreg with reduced thickness and increased width by controlling a gap between two calendar rollers through which the CNT prepreg is passed. In certain examples, the CNT prepreg may comprise from 10% to 90% by mass of CNT material. In other examples, a cross-sectional aspect ratio of the CNT prepreg ranges from 1 to 100. In some examples, the CNT prepreg may include a tenacity after curing that may be greater than 0.8 N/tex, and an IFSS that may be greater than 15 MPa. In other examples, composite materials or articles may be formed of the CNT prepreg disclosed herein.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 shows deficiencies in composite properties when material is prepared using a pre-densified CNT yarn composite article according to SOA.

FIG. 2 shows the loose network in CNT roving used as starting material for preparing a pre-infiltrated polymer CNT roving composite article.

FIG. 3 shows system components for preparing a pre-infiltrated polymer CNT composite according to SOA.

FIG. 4 shows a summary of the influence of different system processing steps on CNT composite properties.

FIG. 5 shows the overall process flow for one embodiment according to the present invention.

FIG. 6 shows another implementation of the overall process flow according to the present invention.

FIG. 7 shows CNT roving behaviors resulting from various process conditions from the art.

FIG. 8 shows process requirements and parameters according to an embodiment of the present invention.

FIG. 9 shows characterization of materials resulting from specific implementations of the present invention.

FIG. 10 shows process requirement and parameters according to another embodiment of the present invention.

FIG. 11 shows characterization of materials resulting from a specific implementation of the present invention.

FIG. 12 shows a summary of the conceptual changes induced by various steps of the present invention.

FIG. 13 shows specific bath chemistries and structures for use with the present invention.

FIG. 14 depicts a flow chart for a CNT prepreg that may be arranged to form composite preforms that are subsequently cured.

FIGS. 15A-J shows (a) a photograph of CNT prepreg spools from various processing conditions, field emission-scanning electron microscopic (FE-SEM) images of (b, c, d) pristine CNT roving, (e, f, g) reference fibers with 55% stretch with calendaring, and (h, i, j) cured CNT composite fiber with 55% stretch at various magnifications. The red arrow indicates the direction of CNT alignment. To fabricate CNT composite fibers the bisphenol A/epichlorohydrin derived liquid epoxy (EPON™ 828) and EMIM-DCA in the CNT prepregs were cured at 165° C. for 1 hour. The EMIM-DCA serves as the cure agent for the epoxy. For selected samples, further removal of residual DMSO solvent from the fiber was explored through a final post heat treatment (post-HT) which was performed at 200° C. for 2 hours.

FIGS. 16A-B shows (a) typical pull-out force-displacement curves of a CNT composite fiber (50% stretch after curing and post heat-treatment) which experienced a gauge-section tensile failure (black line) and a pull-out failure (orange line). For comparison, a reference fiber made without epoxy (60% stretch) is shown (green line). The inset is an expansion of the low displacement section. Arrows indicate de-bonding events. (b) Optical micrograph image of the portion of the pulled-out CNT composite fiber that was originally embedded in the tab. Single fiber pull-out test specimens were prepared and tested. To cure the tabs for CNT composite fibers and reference fibers stretched without epoxy, a cure agent (5 wt. % EMIM DCA) was used with a cure cycle of 165° C. for 2 hours. Ten specimens were tested each with embedded lengths of 0.5 mm to 1.5 mm for the composite fibers and 5 mm to 8 mm for the reference fibers. For fibers with similar diameter and tensile strength, the maximum length that they can be embedded and generate a pull-out failure, instead of a tensile failure in the gauge region, is related to their shear strength, with larger shear strengths requiring shorter embedded lengths. The shorter embedded lengths were used for the CNT composite fibers because preliminary tests indicated that the critical length to achieve pull-out, instead of tensile failure, was much shorter than the critical length for the reference fibers stretched without epoxy. The separation distance between the top and bottom tab was 10 mm and the crosshead speed was 1 mm/min.

FIGS. 17A-E shows the (a) representative tenacity-strain curves of the uncured CNT prepreg, cured, and post heat-treated CNT composite fibers all with 55% stretch and calendaring and the reference CNT fiber stretched to 55% with zoomed inset (b) tenacity, (c) linear density, (d) failure force, and (e) specific modulus before and after curing. Mechanical testing was conducted on the CNT composite fibers in the uncured (prepreg), cured, and post heat-treated states. The prepregs were cut into three pieces after infiltration and stretching to yield as-produced as well as cured and post-HT fiber test specimens. The reference CNT fiber samples stretched without epoxy infiltration were also tested.

The tenacity of the CNT prepreg derived composite fibers was measured using an Instron 5844 with mechanical grips and a 2 kN load cell. The gauge length and crosshead speed for the tensile test were 20 mm and 1 mm/min, respectively. The reference CNT fibers stretched without epoxy infiltration were tested by loading 15 cm of the stretched CNT fiber onto a pneumatic capstan grip (Instron cord and yarn grip type O, Model number 2714-005) and tested at a 9.5 cm gauge length with a 1 mm/min crosshead speed.

For all materials, tenacity (N/tex) was calculated by dividing the measured failure force (N) by the linear density (tex) of each specimen. Note that tenacity (N/tex) is numerically equivalent to the specific strength [GPa/(g/cm³)]. The specific modulus was calculated from the slope of the specific stress vs. strain curve, considering only the interval between 10% and 30% of the ultimate tenacity to eliminate the initial lag in the stress-strain behavior.

FIGS. 18A-G shows (a) typical tenacity-strain curves of the cured and post heat-treated CNT composite fibers with various stretch percentages; (b) Tenacity of the CNT composite fibers; photographs and optical micrographs of failed composite fibers with (c) the reference CNT fiber stretched without epoxy, and (d, e, f) typically processed CNT composite fibers. Inset (e) is a magnified optical micrograph at the tensile failure location showing small diameter fibers within the failed CNT composite fiber. Inset (g) is a CNT composite fiber with higher resin content (˜55 wt. % resin content).

FIG. 19 depicts a table of properties of processed reference CNT fiber and CNT composite fibers.

### DETAILED DESCRIPTION OF THE INVENTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a solvent” include, but are not limited to, mixtures or combinations of two or more such solvents, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to conduct the methods of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or cannot occur, and that the description includes instances where said event or circumstance occurs and instances where it does not.

Current practice to produce high volume fraction structural CNT composites starts with high tenacity CNT yarns where the CNTs that comprise the yarn are highly densified and aligned to yield high tenacity fibers. However, due to the densely packed CNTs in the fiber, it is not possible to sufficiently infiltrate the yarn with resin to enhance CNT to CNT binding. This results in CNT composite articles that may have high axial mechanical properties but very poor shear, transverse properties, and toughness.

The approach developed here starts with tape-like CNT roving composed of CNTs that are more loosely packed and randomly aligned. This starting material offers the advantage of having interstitial spaces that can be penetrated by resin to bind CNT units together so that when the resulting composite fiber is used to build CNT composite articles, improved interaction between CNT and resin in the build unit translates to better transverse properties for the resulting composite article.

High levels of CNT alignment in the network is enabled by the process of the present invention to produce high tenacity CNT tape-like prepreg that is infiltrated with resin. The process involves the controlled application of an electrical current in an ionic liquid/polymer bath to stretch the starting roving as well as infiltrate it with the ionic liquid and polymer.

The resulting high tenacity, tape-like CNT prepreg contains polymer resin and ionic liquid as the latent cure agent/hardener.

The CNT prepreg is fabricated using the stretching process with the ionic liquid in the bath acting as an electrolyte.

Composite articles are fabricated from the CNT prepreg by curing the resin aided by the ionic liquid latent cure agent/hardener.

When the resulting prepreg is used to build composite articles, the improved interaction between CNTs through the resin intermediary within the prepreg translates to a composite article with higher shear and transverse properties as well as higher axial properties.

The process developed combines ionic liquid and electrical current-based stretching of CNT roving with latent ionic liquid polymerized epoxies to produce a resin-infiltrated tape-like CNT prepreg with enhanced interfacial properties and high tenacity resulting from stretching and densification assisted by ionic liquid and the applied electrical current/voltage.

The resin chemistry can be cured to form an integrated composite making the prepreg a material which can be used as the building unit for CNT composite articles with enhanced shear characteristics to yield better transverse properties as well as axial properties.

The method developed is compatible with existing CNT roving electrochemical post-processing methods used currently (U.S. Pat. No. 11,434,581 discloses a method for electrochemically treating a nanofibrous macrostructure without heating) which yields high tenacity yarns but with poor shear and transverse mechanical properties i.e., yarn frays easily when pulled perpendicular to the alignment direction.

The polymerizable resins enable the fabrication of a CNT prepreg from stretchable roving that retains the polymerizable resin in the final composites with enhanced transverse properties as well as axial properties.

The combination of the resin infiltration step with continuous mechanical stretching under an applied electrical current/voltage yields a unique tape-like prepreg with enhanced interfacial and transverse mechanical properties as well as enhanced axial mechanical properties. The resulting CNT prepreg does not fray like the non-infiltrated and highly aligned CNT yarn.

The resin impregnated CNT roving or CNT prepreg is a more robust building unit for producing CNT composite articles. Incorporating polymerizable resin into the CNT prepreg prior to the manufacture of the CNT composite article reduces the depth of resin penetration that has to occur to permit load carrying across all the levels that make up the CNT hierarchical microstructure of the composite article.

Therefore, resin infiltration deep into the hierarchical CNT microstructural networks during composite panel fabrication is not required. Incorporating a polymerizable resin during the prepreg formation step permits load carrying capability across all the individual CNT ensembles that make up the hierarchical microstructure of the CNT composite article.

Improved resin infiltration and attendant increase in shear properties are demonstrated by fiber pull out tests without the dry core failure seen in CNT fibers with no resin infiltration.

Apparent interfacial shear properties are demonstrated by fiber pull out tests.

Improved toughness of resulting CNT composite coupons is shown.

Stretching in this process controls CNT alignment degree, resin content, and cross-sectional aspect ratio of tape-like CNT prepregs.

Improved tenacity in composite fibers derived from the CNT prepregs is shown.

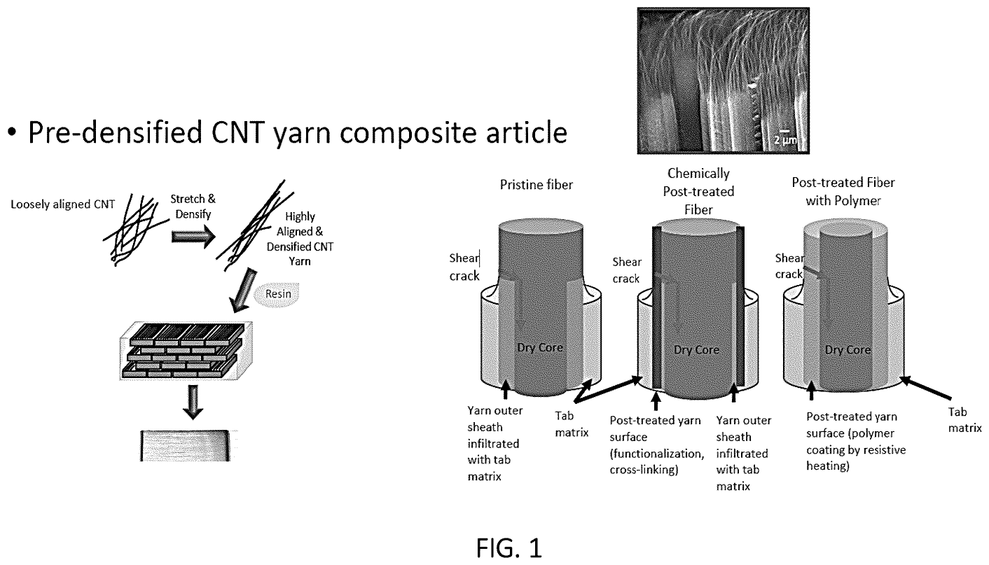

Referring to the drawings, FIG. 1 shows a first approach for preparing a pre-densified CNT yarn composite article according to the state of the art. Loosely aligned CNT fibers are stretched and densified to produce highly aligned and densified CNT yarn. These yarns are coated with resin and wound around a mandrel with tension applied to the CNT yarn to produce CNT composites. Composites formed by this approach generally have good axial tensile strength but may have poor adhesion and transverse tensile strength, compression, flexure and shear properties. Such fibers are prone to develop shear cracks, as shown in FIG. 1.

Composites formed from such pre-densified yarn are typically bound by a thermosetting polymer matrix (e.g., epoxy). The resulting composites demonstrate the following characteristics:
Apparent IFSS of single fiber: <5 MPa.
Specific Short Beam Shear (SBS): <15 MPa (g/cm³)
Specific transverse tensile strength: 7.1 MPa/(g/cm³)
Axial specific tensile strength: 2.0 GPa/(g/cm³)

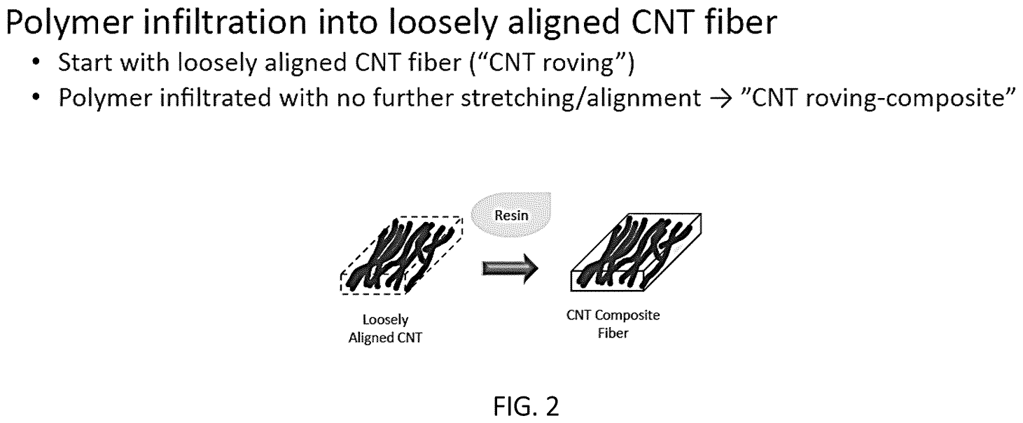

FIG. 2 shows a second approach for preparing a CNT yarn composite article with the loose network in CNT roving used as starting material for preparing a pre-infiltrated polymer CNT roving composite according to the state of the art. According to this approach, loosely aligned CNT fibers, such as in a CNT roving, are infiltrated with resin with no further stretching or alignment to produce a CNT roving-composite.

Composites formed by this approach have good specific transverse tensile strength (e.g., 81.3±12.2 MPa/(g/cm³)), but generally have poor specific axial tensile strength (e.g., 0.85 GPa/(g/cm³)).

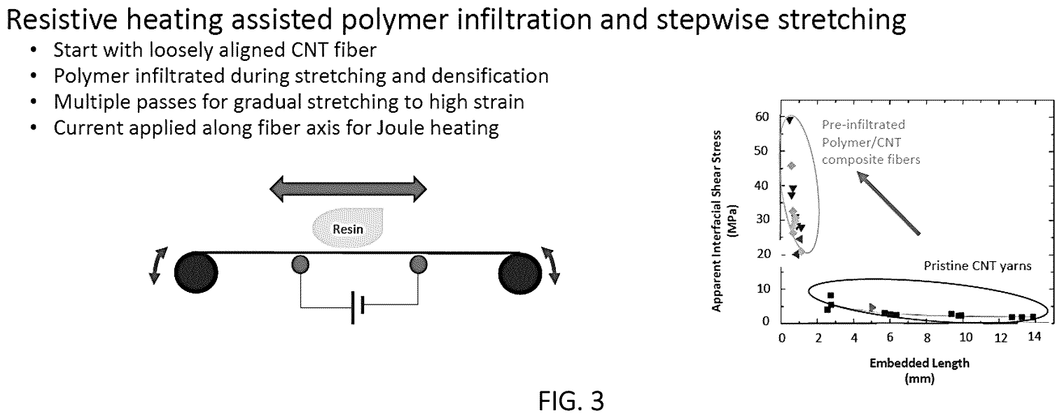

FIG. 3 shows a third approach for preparing a densified CNT yarn composite article according to the state of the art. This approach uses resistive heating assisted polymer infiltration and stepwise stretching. Loosely aligned CNT roving materials are infiltrated during stretching and densification. Multiple passes are made for gradual stretching of the fibers to high strain. Current is applied along the fiber axis for Joule heating.

There are also problems and limitations with this approach.
Apparent IFSS of single fiber ˜60 MPa
Stretching limited to 5% and 0.2 m/min per pass
To achieve 50% stretch, required 10 passes
Consistent stretch above 50% not possible without breakage.
Therefore, unable to reach high alignment and axial strength

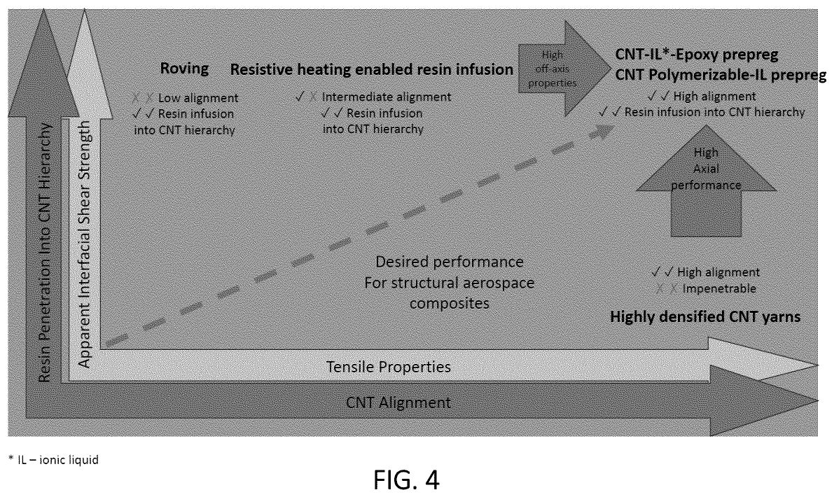

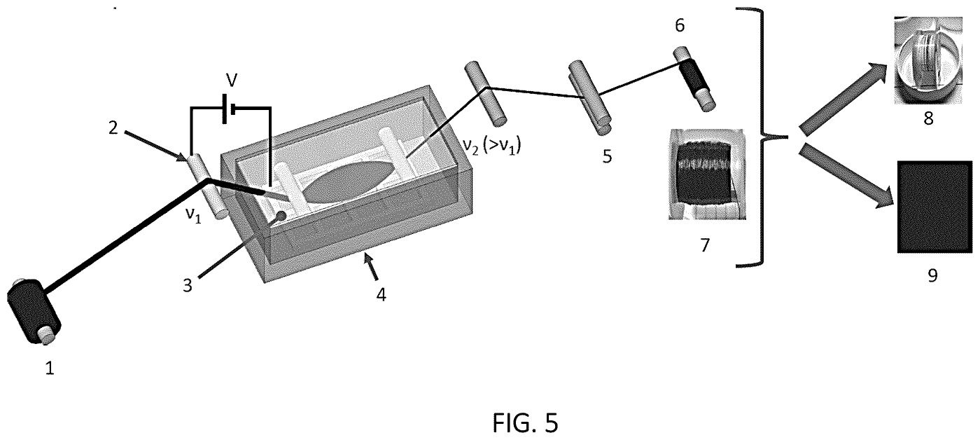

FIG. 4 shows the overall process flow for the invented process, along with nomenclature used. FIG. 5 graphically shows an overall process flow according to the method of the present invention. The process is used to produce CNT/epoxy tape-like prepreg. FIG. 5 illustrates (1) CNT roving, (2) conductive roller, (3) counter electrode, (4) IL-epoxy-solvent bath, (5) calendaring rollers, (6) CNT/epoxy prepreg, (7) is a digital image of a CNT/epoxy prepreg with 50% stretch, (8) is digital image of a cured fiber product derived from CNT/epoxy, and (9) illustrates composite panels that may also be laid up from the prepreg.

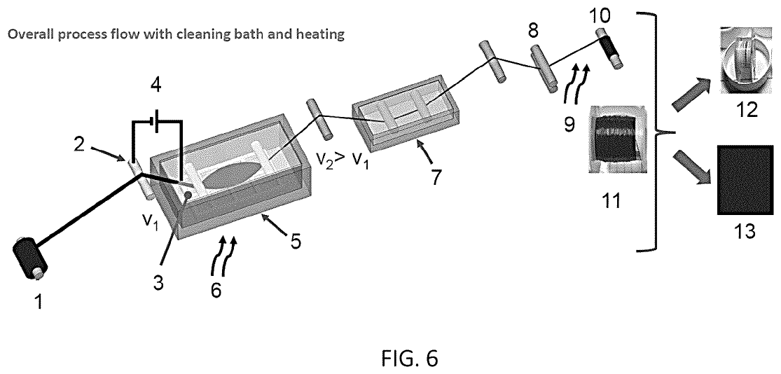

FIG. 6 shows another implementation of the overall process flow according to the method of the present invention. The process is used to produce CNT/epoxy tape-like prepreg similar to the process of FIG. 5, but with a cleaning bath and heating. The process of FIG. 6 may include (1) CNT roving, (2) conductive roller, (3) counter electrode, (4) voltage/current source (5) IL-epoxy solvent bath, (6) heat source to lower bath viscosity, (7) cleaning bath, (8) calendaring rollers, (9) drying (10) CNT/epoxy prepreg, (11) a digital image of a CNT/epoxy prepreg with 50% stretch, (12) digital image of a cured fiber product derive from CNT/epoxy, and (13) composite panels may also be laid up from the prepreg.

Alignment of the CNTs in the roving was achieved by mechanical stretching in the bath containing ionic liquid and epoxy dissolved in DMSO. The apparatus for this work is depicted in FIG. 5. During the process, electric motors were used to rotate rollers at different speeds (v₁ and v₂ with v₂>v₁). Adjusting these speeds while simultaneously controlling the electrical current (or voltage) applied to the system provided control over the extent of stretching and hence CNT alignment and densification as well as the amount of resin and ionic liquid retained in the resulting prepreg material. The practical stretching of the CNT roving occurred between the two rollers inside the bath, that were separated by 7.5 cm. Negative polarity was applied to the CNT roving through a conductive roller while positive polarity was applied to the stainless-steel mesh electrode in the bath. A program was used to control the motors and to apply and monitor the current and voltage during the process. After the first bath there was an acetone densification/cleaning step followed by calendaring which was applied to some of the samples.

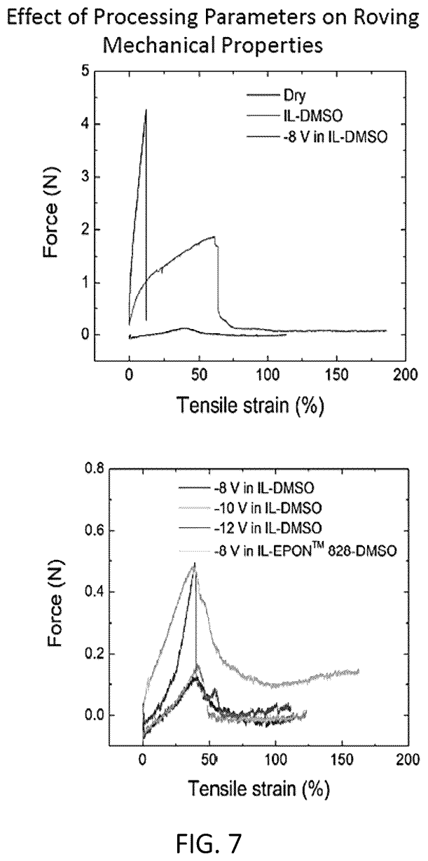

FIG. 7 shows the effects under a range of conditions including baseline processes from the art. In the baseline process the addition of ionic liquid and DMSO without an applied voltage enables larger stretch strains with reduced force compared to dry stretching. In another baseline process the application of a voltage enables further stretching with further reduced force compared to stretching without an applied voltage. In the new art the addition of epoxy into the bath with ionic liquid and DMSO does not impair the stretching strain and stretching force in the bath. Test parameters and observations include:
Dry condition: No voltage, no DMSO, no ionic liquid. Failure strain˜12%, maximum force 4.3 N.
IL-DMSO: No voltage, 0.1 M EMIM DCA/DMSO. Failure strain 61%, maximum force 1.9 N.
IL-DMSO with voltage: Voltages applied (−8 V, −10 V, −12 V), 0.1 M EMIM DCA/DMSO. Failure strain>100%, maximum force<0.5 N.
IL-DMSO with voltage and epoxy: Voltage applied (−8 V), 0.1 M EMIM DCA/DMSO. Failure strain>100%, maximum force<0.5 N.
   Note that there are voltage ranges used that do not yield the desired mechanical performance.

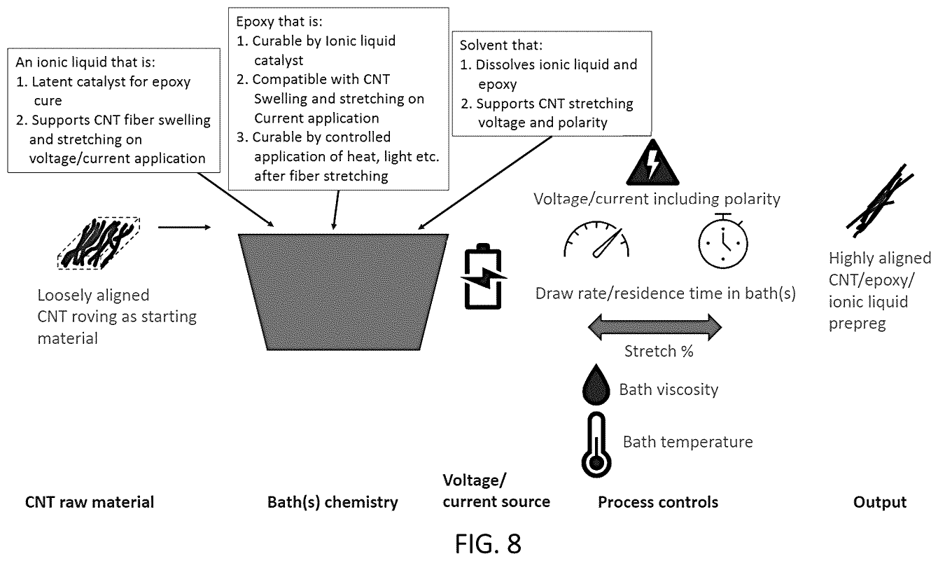

FIG. 8 shows the process requirements for the present invention where an ionic liquid is used as a latent cure agent for epoxy cure. The process starts with loosely aligned CNT roving material as the starting material, provides the material in a chemistry bath, treats the material with a voltage/current source, to provide a highly aligned CNT/epoxy prepreg material.

The chemistry bath is formed of an ionic liquid that is a latent cure agent for epoxy cure and supports CNT roving swelling and stretching upon voltage/current application. The epoxy is curable by the ionic liquid catalyst, compatible with CNT swelling and stretching on the current application, and is curable by controlled application of heat, light, and other parameters after fiber stretching. The solvent used dissolves the ionic liquid and epoxy to provide a stretching and infiltration medium with lowered viscosity and supports the CNT stretching voltage/current and polarity. Heat can also be used to lower the polymerizable ionic liquid viscosity in the stretching bath.

The parameters for the process include the following:
Roving linear density: 10 tex.
Stretch %: 0, 10, 30, 40, 50, 55, 65
Voltage/current: −7 V/60 mA
Rate: 120 m/hr

Additional processing parameters:
Energy range 1-200 ampere-min/g—Combines rate, roving density, and current
Enabling≥65% stretching, therefore, enabling reaching high alignment and axial strength
Controlled resin quantity integrated uniformly in the prepreg enabling≥10 wt % resin content.
   The CNT roving materials were stretched in a bath consisting of ionic liquid EMIM-DCA, EPON™ 828 epoxy, and DMSO. The concentrations of EMIM-DCA and EPON™ 828 in DMSO were 0.1 M and 5.4 wt. %, respectively. An electric current was applied to the CNT roving which served as the working electrode in the stretching bath.

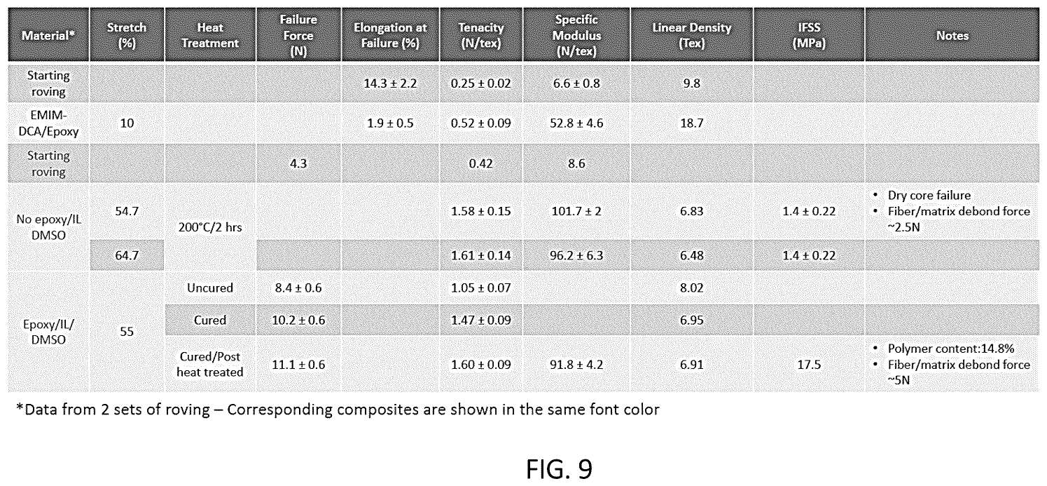

FIG. 9 shows an example of a specific implementation of the present invention along with results obtained. Stretching with polymer infiltration under an applied electrical current/voltage. CNT roving stretched in bath of EMIM DCA/DMSO (ionic liquid/solvent) or EPON™ 828.

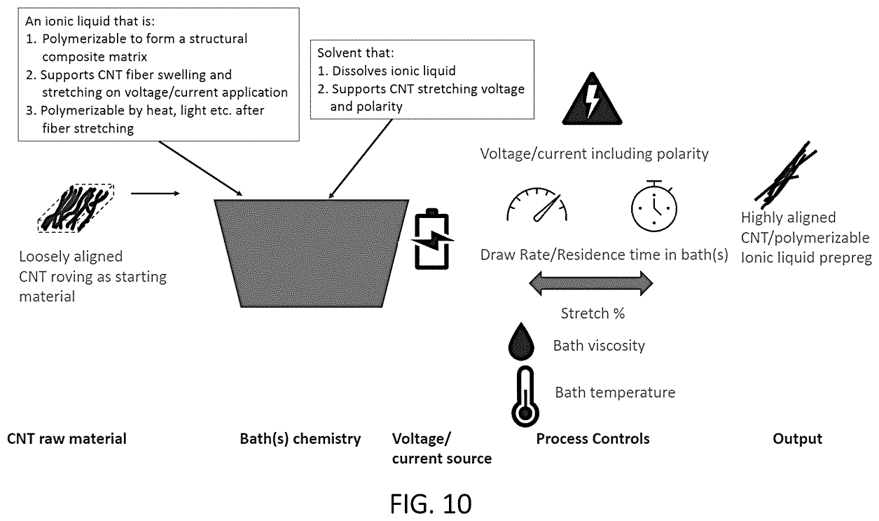

FIG. 10 shows the process requirements for the present invention that utilizes a polymerizable ionic liquid. The process starts with loosely aligned CNT roving as the starting material, provides the material in a chemistry bath, treats the material with a voltage/current source, to provide a highly aligned CNT/polymerizable IL prepreg material. The polymerizable ionic liquid has functionalities to serve as the stretching agent in the bath and the polymer matrix in the resulting composite.

The ionic liquid is polymerizable to form a structural composite matrix, supports CNT roving swelling and stretching on voltage/current application, and is polymerizable by heat, light, and other ways after stretching. The solvent used dissolves the ionic liquid to provide a stretching and infiltration medium with lowered viscosity and supports the CNT stretching voltage/current and polarity. Heat can also be used to lower the polymerizable ionic liquid viscosity in the stretching bath.

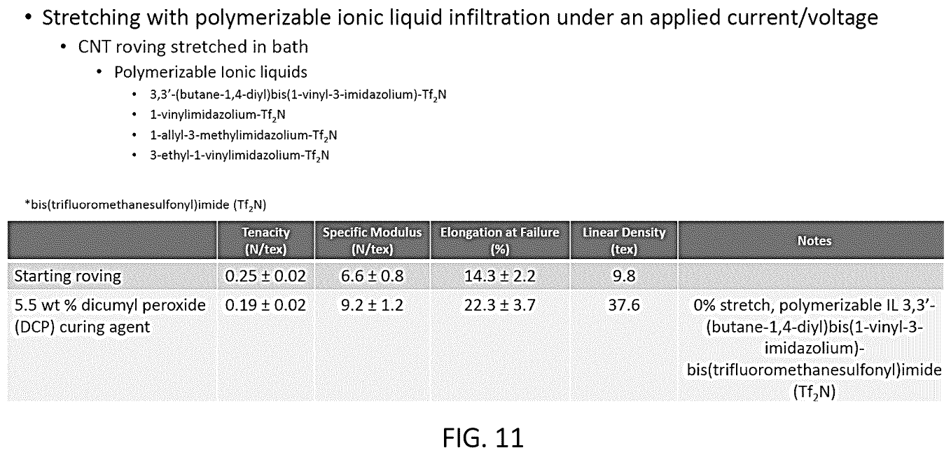

FIG. 11 shows an example of a specific implementation of the present invention along with results obtained. The implementation utilizes stretching with polymerizable ionic liquid infiltration and an applied electrical current. The polymerizable ionic liquid has functionalities to serve as the stretching agent in the bath and the polymer matrix in the resulting composite. Several polymerizable ionic liquids are listed for inclusion in the CNT roving stretching bath.

The parameters for the process include the following:
Roving linear density: 10 tex
Voltage/current: −4 to −12V/60 mA

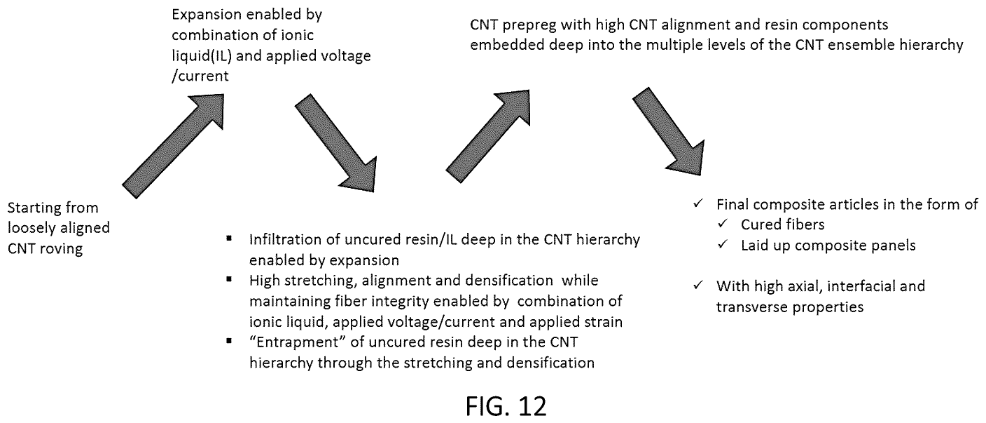

Referring to FIG. 12, the conceptual effect of the processing steps of the present invention are shown. The method begins with loosely aligned CNT roving. A combination of ionic liquid and applied voltage/current permit expansion. Infiltration of uncured resin and ionic liquid deep in the CNT roving hierarchy enable expansion. High stretching, alignment, and densification occur while maintaining the fiber integrity due to the application of strain and the combination of ionic liquid, polymer precursor, and applied voltage/current. Uncured resin is entrapped deep within the CNT prepreg hierarchy through stretching and densification. CNT prepreg with high CNT alignment and resin components are embedded deep within the CNT prepreg hierarchy. Final articles can be fabricated from the prepreg in several ways, depending on the desired application. The prepreg can be cured into composite fibers or laid up and subsequently cured to form composite articles having high axial, interfacial, and transverse properties.

In general, the CNT roving material used is as manufactured, that is, in a loose network of unaligned CNTs. The material is generally hundreds of microns wide and tens of microns thick, having an aspect ratio of tape greater than about 10.

Several potential combinations were used in a processing line; EPON™ 828 epoxy was used as the resin with EMIM-DCA ionic liquid as the latent cure agent for the thermoset resin polymerization; EMIM-DCA ionic liquid also functioned as the electrolyte and lubricant for the prepreg fabrication processes. Acetone, DMSO, and acetonitrile were used as solvents. Use of trihexyl(tetradecyl)phosphonium Bis(2,4,4-trimethylpentyl)phosphinate, another ionic liquid that supports prepreg processing and resin cure, was also demonstrated. To fabricate CNT composite fibers the EPON™ 828 epoxy and EMIM-DCA in the CNT prepregs were cured at 165° C. for 1 hour. For selected samples, further removal of residual DMSO solvent from the fiber was explored through a final post heat treatment (post-HT) which was performed at 200° C. for 2 hours.

Other ionic liquids that would work as latent catalysts with the processing line include 1-butyl-3-methylimidazolium-tetrafluororborate (BMIM-BF₄), 1-butyl-3-methylimidazolium dicyanamide (BMIM-DCA), 1-butyl-3-methylimidazolium chloride (BMIM-Cl), 1-(3-cyanopropyl)-3-methylimidazolium-dicyanamide, 1-(2-cyanopropyl)-3-methylimidazolium-dicyanamide, 1-butyl-1-methyl-pyrrolidinium-dicyanamide, and 1-butyl-3-methyl-pyrrolidinium-dicyanamide.

Polymerizable ionic liquids for the process include 1,3-Bis(1-((7-oxabicycloheptan-3-yl)methoxycarbonyl)methyl)-1H-imidazol-3-ium-Bis(trifluoromethanesulfonimidate) and 3,3-(Butane-1,4-diyl)Bis(1-(4-(((7- oxabicycloheptan-3-yl)methoxy)methyl)phenyl)-1H-imidazol-3-ium-Bis(trifluoromethanesulfonimidate), 3,3′-(butane-1,4-diyl)Bis(1-vinyl-3-imidazolium)-bis(trifluoromethanesulfonyl)imide, 1-vinylimidazolium-Bis(trifluoromethanesulfonyl)imide, 1-allyl-3-methylimidazolium-Bis(trifluoromethanesulfonyl)imide, and 3-ethyl-1-vinylimidazolium-bis(trifluoromethanesulfonyl)imide.

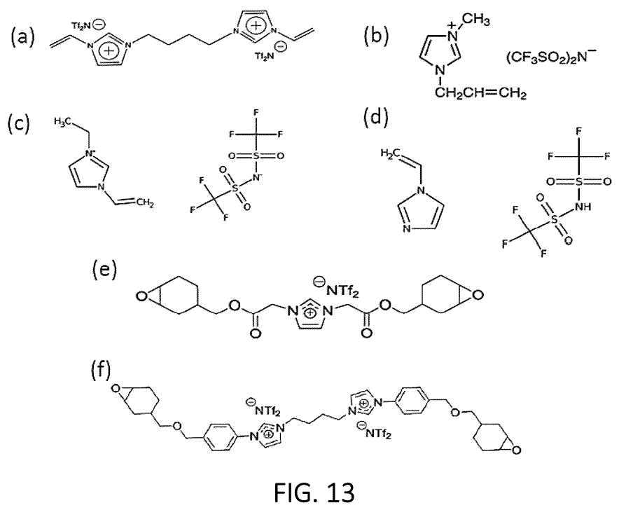

Additional structures for use in bath chemistry according to the invention are shown in FIG. 13.

The invention relates to a process for making CNT/resin (CNT/ionic liquid (IL)/resin) prepreg that has the following properties:
The CNT roving is highly stretched and aligned.
The resin is incorporated deep into the CNT prepreg hierarchy
The prepreg can be assembled into structural articles and cured post the composite formation process
The curing agent for the resin pre-infiltrated into the CNT network is the ionic liquid that also enables controlled stretching and alignment under the controlled application of an electric current
The incorporation of the resin in the CNT prepreg hierarchy provides improved shear strength in the resulting materials
The high stretch and alignment enable by the stretching under current and in the ionic liquid provides high tensile properties

The invention also relates to a process for making CNT/polymerizable ionic liquid prepreg that has the following properties:
The CNT roving is highly stretched and aligned
The resin is incorporated deep into the CNT prepreg hierarchy
The prepreg can be assembled into structural articles and cured post the fiber formation process
The cure of the polymerizable ionic liquid is achieved via thermal, light or another energy source without the requirement for infusion of an additional cure agent into the CNT network.
The polymerizable ionic liquid that also enables stretching and alignment under the controlled application of an electric current.

The incorporation of the resin in the CNT hierarchy provides improved interfacial load transfer in the resulting materials

The high stretch and alignment enabled by the in the polymerizable ionic liquid stretching under an applied electric current provides high tensile properties.

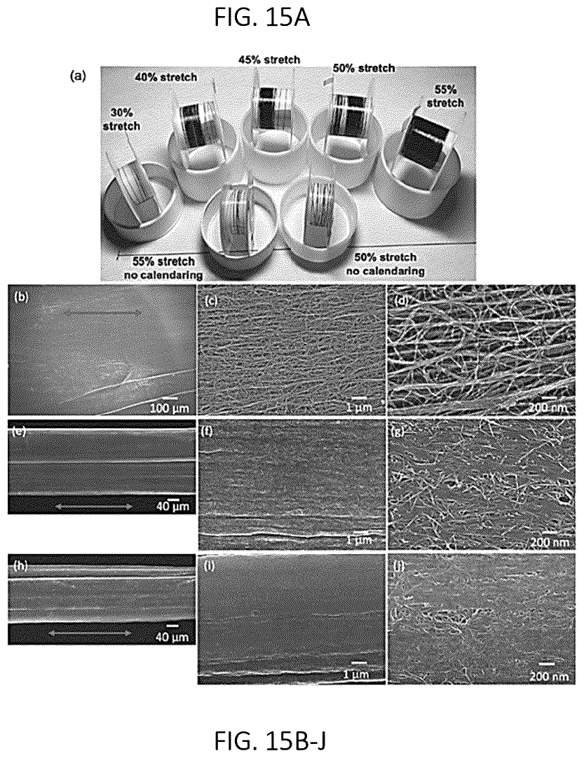

In FIGS. 15-19, CNT composite fibers fabricated with EPON™ 828 epoxy and EMIM-DCA in the CNT prepregs were cured at 165° C. for 1 hour. For selected samples, further removal of residual DMSO solvent from the fiber was explored through a final post heat treatment (post-HT) which was performed at 200° C. for 2 hours. Cure and post-cure heat treatment were conducted in an air oven by vertically hanging about one meter of each fiber supported between two metal rods.

In FIGS. 15-19, a set of reference fibers were processed using the same setup used for making the prepreg but with no epoxy in the stretching bath. These fibers were made using the same starting roving material as the fibers made with epoxy. After processing, the reference fiber was heat treated at 200° C. for 2 hours.

In FIGS. 15-19, the resin content in the CNT composite fibers was calculated based on the mass change that occurred from the process relative to a reference fiber stretched without epoxy at the same stretch percentage. This helps account for the ionic liquid mass, which is expected to be similar between the composite and reference fibers, although there may be some variation in ionic liquid/solvent content or sample to sample linear density variations.

Spools of stretched CNT prepreg were prepared using the apparatus that is depicted schematically in FIG. 5. Examples of several of these runs with various levels of stretch are shown in FIG. 15A. Inspection of the FE-SEM images of the pristine roving in FIG. 15B through FIG. 15D reveals that there is a great deal of porosity available for resin and ionic liquid infiltration. The CNT roving material has a linear density of 9.42 tex and a tenacity of 0.40±0.04 N/tex with CNT bundle diameters in the 20 nm to 30 nm range. Most CNT bundles were aligned along the roving axis and were separated by inter-bundle voids that ranged from tens to hundreds of nanometers. However, some CNTs and bundles were misaligned from the roving axis and formed structures including loops, twists, bridges to neighboring bundles, or physical entanglements.

Relative to the initial roving shown in FIG. 15B through FIG. 15D, stretching to 55% without epoxy had a notable effect on the structure, as shown in FIG. 15E through FIG. 15G. The stretching process reduced the linear density of the roving from 9.42 tex to 6.83 tex because of the elongation, but the packing density and alignment of the bundles clearly increased while the surface porosity decreased. FE-SEM images of the cured CNT composite fiber with 55% stretch are shown in FIG. 15H through FIG. 15J. The CNT fibers appear compacted and wetted with epoxy between bundles. Comparing the CNT composite fiber and reference fiber, the addition of epoxy does not observably alter the structures on the fiber surface.

Single fiber pull-out tests were conducted to assess the quality of resin penetration into the CNT prepregs and the resulting shear properties of the cured CNT composite fibers. From the pull-out tests the failure model and apparent IFSS were determined and compared to the reference fibers. As discussed in the introduction, CNT fibers often suffer from poor shear strength, which can manifest itself in low apparent IFSS in pull-out tests and other shear composite sample tests. Infiltrating the hierarchical nanotube microstructure with polymer improves shear properties which can be characterized using a pull-out test.

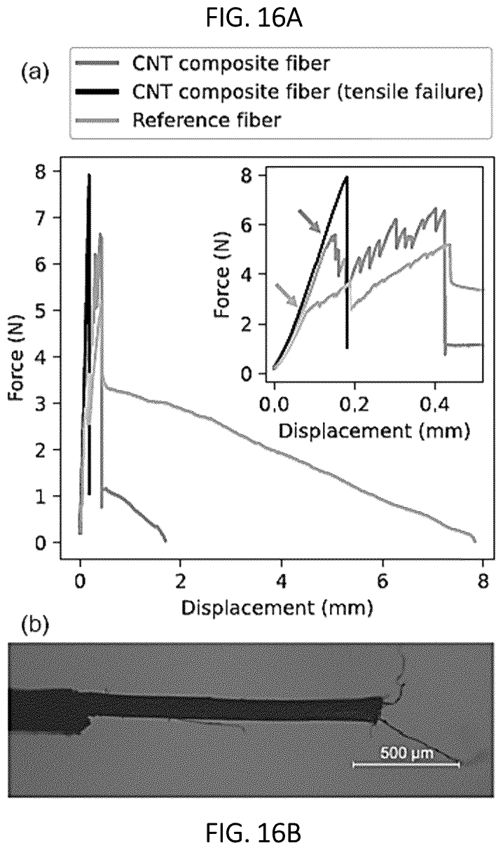

As shown in FIG. 16A, the reference fibers were pulled-out with a dry core failure throughout the entire embedded fiber (7.3 mm embedded length for this case). The resulting apparent IFSS was 1.40±0.22 MPa. The reference fibers do not fail at the interface between the fiber and the matrix but failed within the dry core of the fiber leaving a thin outer sheath of CNT material in the polymer tab.

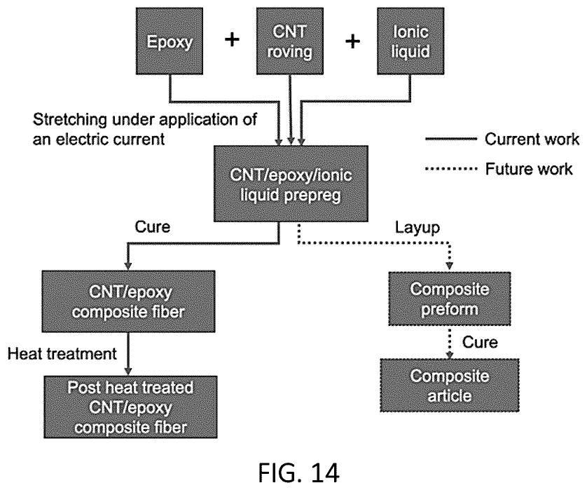

As depicted in FIG. 14, the intended application of this material is as a CNT prepreg that can be arranged to form composite preforms that are subsequently cured. Therefore, pull-out test specimens were fabricated with the uncured CNT prepreg embedded into the sample tab and both were co-cured together. Despite the target embedded lengths of 0.5 mm-1.5 mm all samples failed in the gauge section, which indicated improved shear strength relative to the reference fibers but did not permit quantification of their apparent IFSS.

Next, samples were fabricated where the CNT composite fibers were first cured and then embedded into the tab. Again, the composite fibers mostly did not experience pull-out failure and instead failed within the gauge section between the two tabs as shown in FIG. 16A (black line). This tensile failure occurred despite the shorter 0.5 mm-1.5 mm embedded lengths, indicating that the load transfer length is much shorter for these fibers than the reference fibers. Only one specimen out of ten had a pull-out failure (orange line). The apparent IFSS of the single specimen measured from pull-out failure was 17.50 MPa with a 1.46 mm embedded length. The de-bond force of the composite fiber to the matrix was ˜5 N compared to the CNT fiber without epoxy of ˜2.5 N as indicated with arrows in FIG. 16A. Many small load-drops after the initial de-bond event were observed during pull-out of the embedded fiber resulting in a jagged force-displacement curve. This indicates that the post de-bond failure behavior of the composite fiber was distinctly different than that of the reference fiber. The morphology of the CNT composite fiber after pull-out is shown in FIG. 16B. The section of the composite fiber that was pulled-out had a relatively smooth surface with a portion torn-off from the main body of the pulled-out fiber and partial failure of the fiber where it was embedded in the tab. The failure mode of the composite fiber tested by pull-out was somewhat similar to the multiple failures observed from tensile tested CNT composite fiber.

Examination of the FE-SEM images in FIGS. 15B-J suggests that the stretching process leads to a more highly aligned and organized fiber, but quantitative comparisons are necessary to understand the effect of processing parameters on the resulting properties. To enable this, CNT prepregs were prepared with various stretch percentages (with calendaring applied) and compared to the original roving material and reference fibers stretched without epoxy. Prepreg fibers characterized were uncured, cured, and cured with a post-HT to remove residual DMSO.

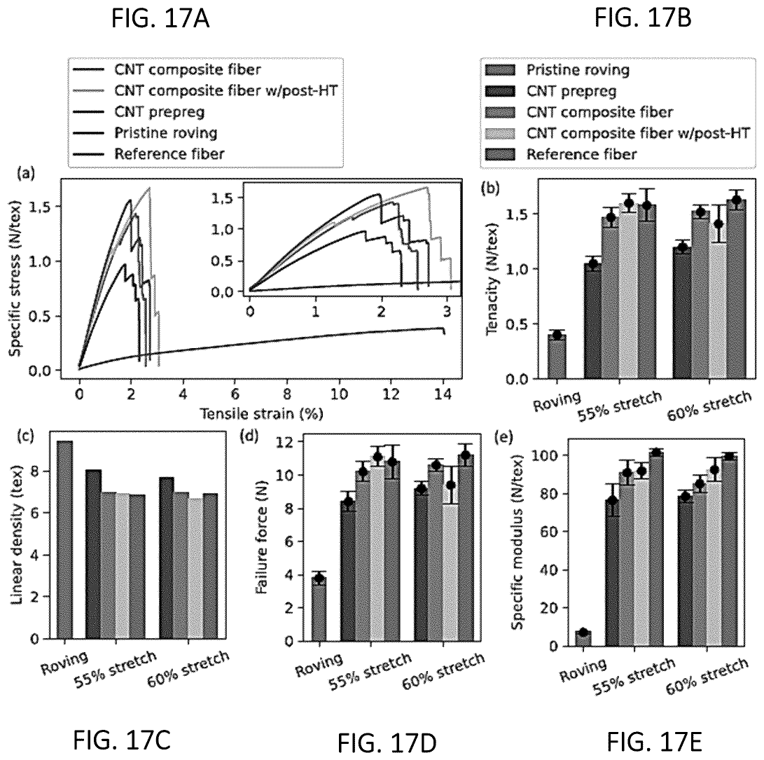

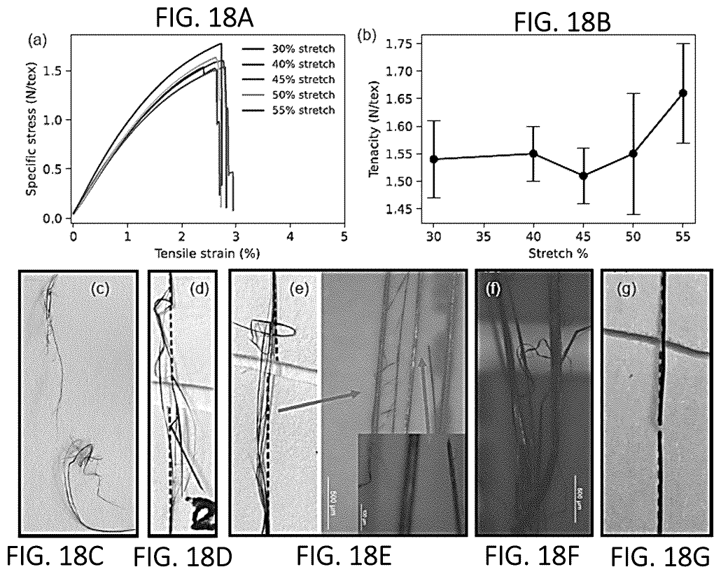

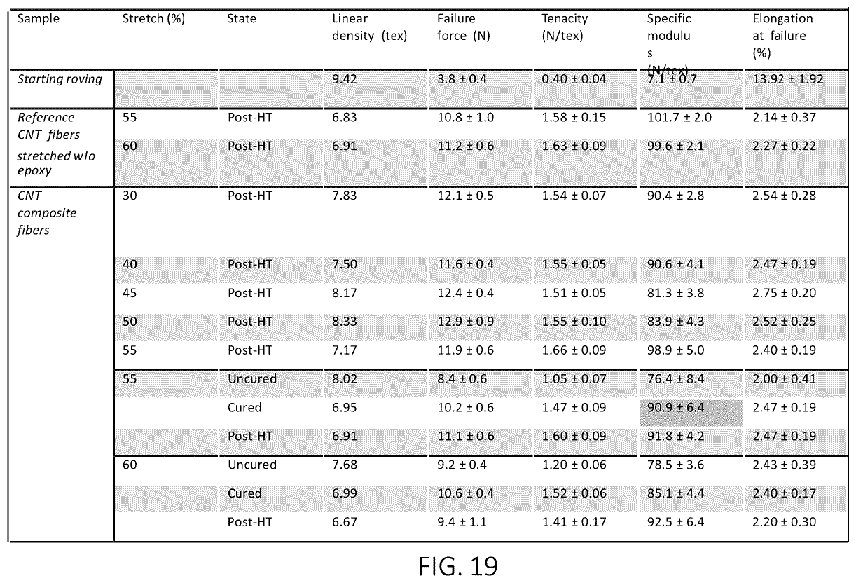

The properties of the stretched roving change after curing and heat treatment, as expected. Representative specific stress-strain curves are shown in FIG. 17A and properties are tabulated in FIG. 19. Uncured, as-produced CNT prepregs had the lowest tenacity, which increases after curing and heat treatment as shown in FIG. 17B. The reference fibers also decreased in linear density after a heat treatment (not shown) indicating some residual solvent was removed. All processing conditions result in fibers with improved tenacities relative to the starting roving (0.40±0.04 N/tex), with the cured and heat-treated fibers having an improvement of >350%.

The increase in tenacity after curing and heat treatment can be attributed to both a decrease in linear density and increase in failure force. For example, the linear density of the CNT prepreg decreased from ˜8 tex to ˜7 tex after curing and heat treatment with 55% stretch as shown in FIG. 17C. The failure force, shown in in FIG. 17D, increased from 8.4 N to 11.0 N (p value<0.00). The decrease in linear density is likely from evaporation of solvent, while the increase in failure force can be attributed to improvements in properties from polymerization of the epoxy. It is also possible that the residual solvent is also reducing the failure force of the uncured prepreg. All subsequently reported cured fibers and reference fibers included heat treatment.

To understand the effect of epoxy in the resulting fiber tensile properties, the cured and heat-treated fibers can be compared to the reference fiber, shown in FIGS. 17A-B. The tenacity was comparable, indicating that the addition of epoxy did not fundamentally alter the stretching behavior. For example, for the CNT composite fiber with 55% stretch, the tenacity and specific modulus were not statistically distinguishable from those of the reference fibers, with p values of 0.26 and 0.24 respectively. The failure strains in the CNT composite fibers with 55% stretch, shown in FIG. 19, were also statistically similar to the reference fibers (p value of 0.18). However, the maximum failure forces of the CNT composite fibers were slightly improved after epoxy incorporation, compared to those without epoxy (p value of 0.046), which may be due to improved interactions between the CNT bundles and infiltrated epoxy caused by nano-scale hierarchical structure formation.

The resin content is important for the prepreg processability into composite articles as well as the final properties of those articles. A polymer content of about 15 wt. % was estimated for the CNT composite fiber with 55% stretch. These results indicate that the mechanical performance of the composite fibers could be improved if the resin content was increased.

Because a high degree of stretching may squeeze resin out of the prepregs, a study of composite fiber properties at lower degrees of stretch was undertaken. Shown in FIG. 18A are the typical specific stress-strain plots for a series of composite fibers stretched between 30% and 55% in 5% increments, with otherwise identical processing conditions. The tenacity of the CNT composite fibers is not sensitive to the level of stretch between 30% and 55%, as shown in FIG. 18B. However, fewer premature failures during stretching were observed with reduced stretching. For composite fiber production runs in which length of run is a high priority or in which a balanced combination of multiple mechanical properties such as tensile, compression, shear, and fracture toughness is required, stretching to smaller extents could be an attractive alternative.

Beyond the measured properties, examination of how the fibers failed provides important insights. Representative post-failure images of fibers are shown in FIG. 18C through FIG. 18G. The reference fiber, shown in FIG. 18C, failed with multiple breakages in multiple locations. This failure behavior is typical for dry CNT fibers or bundled yarns of ultra-high-molecular-weight polyethylene. The fibers shown in FIG. 18D through FIG. 18F separated into multiple, smaller sub-structures that have broken at different locations along the fiber axis. The resin content for the fiber shown in FIG. 18F was computed to be ˜10 wt. %. To understand what effect higher resin content may have on failure mode, a sample was made without the acetone or calendaring steps. This fiber is shown in FIG. 18G and had a clean single breakage and was found to have a particularly high resin content of ˜55 wt. % which likely contributed to the change in failure mode. These images reflect the range of failure behaviors observed, from the clean breakage of the high resin content fiber to the multiple sub-structures seen in the resin-free fiber. This contrast in failure behavior at the extremes, and the incremental evolution of the intermediary fiber failures, suggests that incorporation of polymer into the stretched CNT fiber enhances the interactions between adjacent bundles.

It is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

What is claimed is:

1. A method for producing a carbon nanotube (CNT) prepreg comprising:
providing a loosely networked and porous CNT material;
introducing the CNT material into a bath comprising ionic liquid and uncured thermosetting resin;
applying an electrical potential or current between the CNT material and a counter-electrode in the bath;
stretching the CNT material; and
impregnating the CNT material with the ionic liquid and the uncured thermosetting resin.

2. The method of claim 1, wherein the ionic liquid is a latent cure agent for the thermosetting resin.

3. The method of claim 1, wherein the ionic liquid comprises 1-ethyl-3-methyl imidazolium-dicyanamide, trihexyl(tetradecyl)phosphonium Bis(2,4,4-trimethylpentyl)phosphinate and combinations thereof.

4. The method of claim 1, further comprising adding a single organic solvent or blend of organic solvents into the bath such that a viscosity of the liquid in the bath is reduced.

5. The method of claim 1, further comprising heating the bath such that a viscosity of the liquid in the bath is reduced.

6. The method of claim 1, wherein the thermosetting resin comprises a single epoxy resin or combination of epoxy resins.

7. The method of claim 1, wherein the thermosetting resin comprises a single cyanate ester resin or combination of cyanate ester resins.

8. The method of claim 1, wherein the CNT material comprises one of single wall nanotubes, double wall nanotubes, multiwall nanotubes, or combinations thereof.

9. The method of claim 1, wherein speeds of an entry roller and an exit roller differ from each other to control a magnitude of CNT material stretching.

10. The method of claim 1, wherein a stretch magnitude is between 0.5% and 99.5% of the CNT material's strain at break in the bath.

11. The method of claim 1, wherein the electrical potential applied between the CNT material and the counter electrode produces either positive or negative polarity on the CNT material.

12. The method of claim 1, wherein the applied electrical potential or current between the CNT material and the counter-electrode in the bath is 1 to 200 ampere-minute per gram of CNT material.

13. The method of claim 1, further comprising washing and drying of the CNT material.

14. The method of claim 1, further comprising calendaring the CNT prepreg to produce a tape-like CNT prepreg, the thickness of the tape-like CNT prepreg being less than the thickness of the CNT prepreg, and the width of the tape-like CNT prepreg being greater than the width of the CNT prepreg.

15. The method of claim 14, further comprising controlling a gap between two calendar rollers through which the CNT prepreg is passed during the calendaring step.

16. The method of claim 1, wherein the CNT prepreg comprises from 10% to 90% by mass of CNT material, wherein a cross-sectional aspect ratio of thickness to width is from 1 to 100, wherein the prepreg tenacity after curing is greater than 0.8 N/tex, and wherein an interfacial shear strength is greater than 15 MPa.

17. A composite product comprising CNT prepreg formed by the method of claim 1.

18. A method for producing a carbon nanotube (CNT) prepreg comprising:
providing a loosely networked and porous CNT material;
introducing the CNT material into a bath comprising polymerizable ionic liquid;
applying an electrical potential or current between the CNT material and a counter-electrode in the bath;
stretching the CNT material; and
impregnating the CNT with the polymerizable ionic liquid.

19. The method of claim 18, wherein the polymerizable ionic liquid comprises 3,3′-(butane-1,4-diyl)Bis(1-vinyl-3-imidazolium)-Bis(trifluoromethanesulfonyl)imide, 1-vinylimidazolium-bis(trifluoromethanesulfonyl)imide, 1-allyl-3-methylimidazolium-bis(trifluoromethanesulfonyl)imide, 3-ethyl-1-vinylimidazolium-bis(trifluoromethanesulfonyl)imide, 1,3-Bis(1-((7-oxabicycloheptan-3-yl)methoxycarbonyl)methyl)-1H-imidazol-3-ium-Bis(trifluoromethanesulfonimidate), 3,3-(Butane-1,4-diyl)Bis(1-(4-(((7-oxabicycloheptan-3-yl)methoxy)methyl)phenyl)-1H-imidazol-3-ium-Bis(trifluoromethanesulfonimidate) or a combination thereof.

20. A composite product comprising of CNT prepreg formed by the method of claim 18.
